(19) United States
(12) Patent Application Publication
(10) Pub. No.: US 2024/0177613 A1
(43) Pub. Date: May 30, 2024

(54) REMOTE ID CONFLICT SYSTEM

(71) Applicant: Zing Drone Delivery Inc., Palm City, FL (US)

(72) Inventor: Ian Annase, Palm City, FL (US)

(21) Appl. No.: 18/520,548

(22) Filed: Nov. 27, 2023

Related U.S. Application Data
(60) Provisional application No. 63/385,108, filed on Nov. 28, 2022.

(51) Int. Cl. G08G 5/00

(52) U.S. Cl. CPC G08G 5/0013; G08G 5/0069

(57) ABSTRACT

The invention relates to a combination of hardware and software solutions which will allow all drones (Unmanned Aerial Vehicles—UAVs) to have a digital license plate (remote ID) that broadcasts the drone's coordinates, velocity, and altitude through Wi-Fi and Bluetooth radio signals publicly so that a drone can be uniquely identified and its location, vector, velocity and altitude visible to the public using a system of the instant invention.

### CROSS-REFERENCE TO RELATED APPLICATIONS

This application claims the benefit of U.S. Provisional Patent Application No. 63/385,108, filed on Nov. 28, 2022, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

There is a concept known as Unmanned Traffic Management in the drone industry. It is similar to Air Traffic Control for crewed aircraft but it is completely automated. It was envisioned for drone operators to plan flights and thereby avoid accidents and interference with one another through this planning. Initially when remote ID was initially proposed by the Federal Aviation Administration (FAA), there was going to be a network component that meant all drones would be visible on the internet. This system was deemed too complex and the FAA decided to go with a broadcast-only solution where drones transmit Bluetooth and Wi-Fi information that contains their GPS position, altitude, and velocity information for use by law enforcement and the public.

There are currently numerous commercial drone operations around the United States, but they are limited because regulators do not allow operators to fly outside of their visual line of sight. This is usually referred to as VLOS (Visual Line of Sight) and is the main hurdle in the drone industry. VLOS is a safety restriction and refers to a drone flying a long distance and further limited by risk reduction measures. In order to operate Beyond Visual Line of Sight (BVLOS), drone operators must prove how they can reduce their risk to other aircraft.

The current legislation with respect to unmanned aerial vehicles (UAVs) and remote ID is the “digital license plate” for drones which contains the GPS location, altitude, and velocity of the aircraft is required by the FAA for all manufacturers to begin including it in their aircraft starting in September of 2022. All drone operators will be required to operate with remote ID compliance by September of 2023. This information is to be broadcasted out via Bluetooth and Wi-Fi so that it is accessible by devices on the ground such as smartphones.

The instant invention further relates to the field of unmanned aerial vehicles (UAVs) and an onboard or ground-based detection system for UAVs to detect drones broadcasting remote ID information, which contains the current and takeoff locations and the drone's latitude, longitude, velocity, and altitude. location and velocity information via Wi-Fi or Bluetooth so interested parties may detect and identify the UAV and that information can be used by operators to deconflict with other nearby UAVs.

### 2) Description of Related Art

Currently the state of the art includes the introduction of numerous unman vehicles into the air space for commercial, industrial, governmental, and recreational purposes. This creates a need for the capability to track the whereabouts of unmanned vehicles operating in the air, on the land, and on/in the water. Therefore, there is a current requirement for the introduction of a digital license plate and remote ID system comprising at least confirmable/verifiable, and/or registered/recorded digital identity for an unmanned vehicle (drone, robot, wheeled vehicle) associated with verified owner/operator information attached.

This creates the need for the next step of the remote ID including the drone's latitude, longitude, velocity, and altitude as well as the information contained in the remote ID.

### BRIEF SUMMARY OF THE INVENTION

The instant invention in one form is directed to a combination of hardware and software solutions which will allow all drones (Unmanned Aerial Vehicles-UAVs) to have a digital license plate (remote ID) that broadcasts the drone's coordinates, velocity, and altitude through Wi-Fi and Bluetooth radio signals publicly so that a drone can be uniquely identified and its location, vector, velocity and altitude visible to the public.

The instant invention remote ID conflict software provides the enhance safety case for operators to expand their capabilities by providing the operators with the information to avoid drone to drone collisions.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows the system diagram for the remote ID detection and deconfliction system for UAVs.

FIG. 2 shows a flow chart of the remote ID conflict detection system

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms unmanned aerial vehicles (UAVs) and drone as used interchangeably to mean an aircraft without any human pilot, crew, or passengers on board.

The terms UAV and UAS are used interchangeably within the specification. The term UAV represents the specific vehicle whereas a UAS encompasses everything necessary for the UAV to operate smoothly and either independently or semi independently.

The term unmanned aerial vehicles (UAVs) as used in the specification is meant to mean an unmanned aerial vehicle, commonly known as a drone. This is an aircraft without any human pilot, crew, or passengers on board. UAVs are a component of an unmanned aircraft system, which includes a ground-based controller and a system of communications with the UAV.

Prior to a discussion of the preferred embodiment of the invention, it should be understood that the features and advantages of the invention are illustrated in terms of a system for use with an aircraft without any human pilot, crew, or passengers on board.

The instant invention uses the remote ID information to inform UAV operators of the proximity and location of other nearby drones to enhance situational awareness and reduce the risk of collisions. It accomplishes this by displaying the information to operators to see where other drones are located within the vicinity they are operating in and when other aircraft enter the detection range. The system also broadcasts the proximity information of other UAVs over a cellular network to display the proximity and collision risk information available to the UAS and the operator to assist them in taking evasive action. The instant invention also incorporates an attachable detection device that broadcasts the location of nearby UAVs to increase the operator's situational awareness and reduce the risk of a collision with another UAV. The operators or users can see the proximity information of the UAVs in a specific area by viewing the broadcast information on a smart device, computer or dedicated computing device that is connected to the remote ID detection system.

The instant invention is a device which comprises of a combination of hardware and software solutions which will allow all drones (Unmanned Aerial Vehicles-UAVs) to have a digital license plate (remote ID) that broadcasts the drone's coordinates, velocity, and altitude through Wi-Fi and Bluetooth radio signals publicly so that a drone can be uniquely identified and its location, vector, velocity and altitude visible to the public. The remote ID information includes a Drone ID that is registered with the FAA to tie the information to an individual.

The instant invention comprises the following components
a. at least one UAV capable of emitting remote ID information via Bluetooth and/or Wi-Fi;
b. a remote ID detection device;
c. a Bluetooth and Wi-Fi Receiver Antennae;
d. a cellular antenna 120;
e. a cellular system and tower;
f. a cloud server; and
g. a computer or smart device having a computer or smart device application for displaying drone location information;

The instant invention provides users with a detection and deconfliction system leveraging the remote ID signals of UAVs. The system can be configured to provide one or more of the following:
a. A mechanism that attaches the detection device directly to the UAV.
b. A mechanism that fixes the device to the ground on a tripod.
c. A mechanism that stores the historical proximity location on the device.
d. A mechanism that enables the device to switch between cellular networks.
e. A system that informs the operator of evasive maneuvers based on drone proximities.
f. A system that connects directly to the flight controller of the aircraft to make autonomous evasive maneuvers.
g. A mechanism that calculates the collision risk based on the location, altitude, and velocity of the drones that are detected within proximity.
h. A mechanism immediately notifies the UAS operator once the system detects a drone within range.
i. A mechanism to inform UAS operators of other drones that they may be on a collision course with another aircraft and possible evasive actions.
j. A method to register the device with public safety so that it may display Personal Identifiable Information (PII) for government agencies.
k. A method to use the timestamps associated with the remote ID information pings to detect the heading of the drone and the time to a potential collision.
l. A method to detect the descent or ascent rate of the other UAV by analyzing the available remote ID information over a set period.
m. The device may be placed on a ground station and detect the UAV of the operator as well as the other drones flying in the vicinity instead of being onboard the drone.

Additionally, the instant invention provides the user with the following advantages:
a. A means for UAV operators to see the locations of nearby drones using remote ID.
b. A method to leverage Bluetooth, Wi-Fi, and radio broadcast signals being transmitted from UAVs to identify and detect drones flying in proximity to an aircraft.
c. A means to inform and alert UAV operators so that they can avoid colliding with nearby drones.
d. An approach to deconflict the drone with other drones based on their proximity and velocity.
e. A means to identify the risk level of a drone that is flying within proximity
f. A means to alert the operator when a new drone enters the range
g. A method to extend the detection range of nearby Bluetooth and Wi-Fi radio signals.
h. The deconfliction method uses remote ID information that is publicly accessible to make calculations of collision risk.
i. The ability to utilize signal strength of incoming radio signals to determine the proximity of other UAVs operating in the airspace.

The instant invention can also be configured with:
a. receivers that enable it to detect Bluetooth and Wi-Fi signals from nearby operating UAVs.
b. a SIM card that enables it to send the proximity information to the cloud.
c. a storage device that enables it to store historical proximity data.
d. the instant invention can be on the ground or affixed to an aircraft to increase the proximity detection range of relevant aircraft.

Currently with respect to unmanned aerial vehicles (UAVs) the remote ID is a “digital license plate” for drones which contains the GPS location, altitude, and velocity of the aircraft and it is required by the FAA for all manufacturers of UAVs aircraft starting in September of 2022. All drone operators will be required to operate with remote ID compliance by September of 2023. This information is to be broadcasted out via Bluetooth and Wi-Fi so that it is accessible by devices on the ground such as smartphones, dedicated computing devices and computers.

Over time, drones will become increasingly prevalent in our airspace. There are currently over 250,000 licensed commercial drone pilots in the United States. This number is only growing exponentially and companies are also beginning to acquire large fleets of drones that can be operated autonomously. Therefore, there is a need for a Detection And Avoidance (DAA) technology to enable the operations of the drone fleets in the future to fly safely as the number of drones increases to support both commercial, recreational and government use.

Drone to drone collision avoidance software is commonly referred to as deconfliction software or Detect and Avoid (DAA) software throughout the industry. Deconfliction software can enable certifications and waivers for operators so that they can operate the drones or UAVs autonomously and expand the range of their operations.

The instant invention uses the location information in order to provide spatial awareness for drone operators. This prevents them from colliding with other drones. The instant invention collects the remote ID signals with a wireless system which can use a wireless protocol such as Bluetooth, Bluetooth LTE, Zigbee, Z-Wave, and Wi-Fi receiver and then broadcast that data to a cloud server via a cellular module. The instant invention then displays this information to the operator via an application and provides suggestions to avoid collisions. The potential collision information can be used to autonomously to avoid a collision or it can be provided to the operator as a recommendation so that they can manually avoid a collision. The instant invention combines the two technologies to create remote ID conflict technology. The cloud database contains the any of the following UAV attributes for the UAV in any particular three-dimensional space such as GPS coordinate, vector, altitude, and velocity of the operator's drone and all other drones in the vicinity. The information can be utilized to display the various UAV information on a map displayed on a smart device or computer device using the instant invention. The operator logs into the instant invention through a web portal that is provided to the public via a public domain. This allows them to select a specific three-dimensional zone. Then their smart device is enabled so that they can see all the drones or UAVs in the zone.

The remote ID signal detection device for Unmanned Aircraft Systems (UAVs) may, be embodied in many different forms and should not be construed as being limited to the embodiments set forth herein; rather, these embodiments are provided by way of illustration only and so that this disclosure will be thorough, complete, and fully convey understanding to those skilled in the art. The remote ID detection device can be equipped to directly communicate with the drone to perform onboard autonomous navigation.

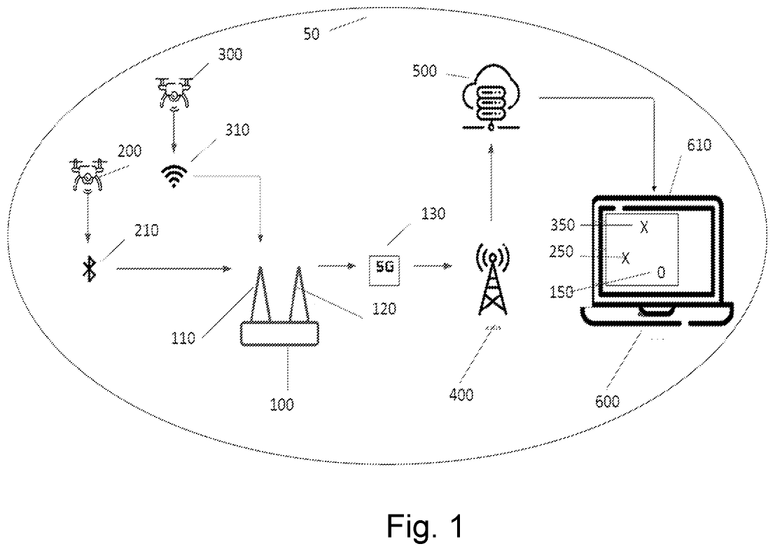

Referring now to the drawings FIG. 1 there is shown the remote ID detection and deconfliction system 50 for UAVs of the instant invention, the system comprises of the following components: a remote ID detection device 100, a Bluetooth and Wi-Fi Receiver and Antennae 110, a cellular device and antennae 120, a UAV emitting remote ID information via Bluetooth 200, a UAV emitting remote ID information via Wi-Fi 300, A cellular tower and antenna 400, a cloud server 500, and a computer displaying drone location information 600.

These components are combined by the instant invention such that each component provides the following benefits to the users of the system. The remote ID detection device 100 has a Bluetooth and Wi-Fi Receiver 110 that can detect Bluetooth signals 210 and Wi-Fi Signals 310 coming from the two UAV 200 and UAV 300 flying nearby. The Bluetooth and Wi-Fi signals contain remote ID information for the UAV 200 and UAV 300, which includes the any of the following vector, coordinate, altitude, and velocity. The information is transmitted via cellular protocol 130 to the cell tower 400. The cell tower sends the information to the cloud server 500. The cloud server sends the location information to the application on the computer or smart device 600 dashboard 610. The dashboard 610 displays the current location of the remote ID detection device 150, the location of the Bluetooth-enabled drone 250, and the location of the Wi-Fi-enabled UAV 300. This information is processed on the cloud server 500 to contain information such as collision warnings and suggested maneuvers. It should be noted that the components of the remote ID detection and deconfliction System 50 are not limited to the ones mentioned in the above use case. Remote ID detection and deconfliction System 50 can be affixed to a drone or placed on a ground station for deconfliction.

The cellular protocol 130 can be selected from the group comprising of 3G, 4G, LTE, 4G LTE, 5G and 5G VOLTE.

The wireless network protocols which can be used by the instant invention include but are not limited to a wireless protocol such as Bluetooth, Bluetooth LTE, Zigbee, Z-Wave, and Wi-Fi.

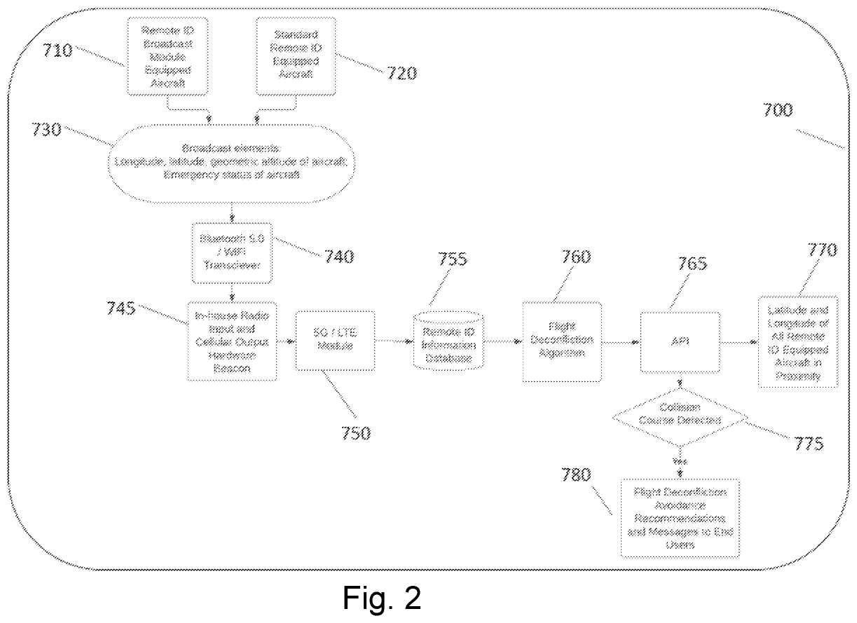

FIG. 2 shows a flow chart of the remote ID conflict detection system 700. The remote ID broadcast module equipped aircraft 710 and the standard remote ID equipped aircraft 720 broadcast elements 730 using the Bluetooth/Wi-Fi transceiver 740. Broadcast elements 730 comprise of longitude, latitude, geometric altitude of aircraft and emergency status of aircraft. The system 700 has an in-house radio input and cellular output hardware beacon 745 that uses a cellular module 750 to transmit remote ID information to a database 755.

The system then utilizes a flight deconfliction algorithm 760 to determine the best course of action to avoid a collision if need and an API 765 then send latitude and longitude of all remote ID equipment aircraft in proximity to any device viewing a particular air space 770. If a possible collision is detected 775 the system 700 sends flight deconfliction avoidance recommendations and messages to the end user managing the remote ID broadcast module equipped aircraft 710 and the standard remote ID equipped aircraft 720. The cellular module 750 can be selected from any cellular protocol which can be transmitted or received by the in-house radio input and cellular output hardware beacon 745.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. (canceled)

2. A remote ID detection and deconfliction system for at least one UAV comprising:
a. said at least one UAV capable of emitting remote ID information via a wireless network protocol using a wireless transceiver;
b. a remote ID detection device capable of receiving said remote ID information via a wireless network protocol using a wireless transceiver;
c. a cellular module;
d. a cloud server and said cloud server having a cloud database;
e. a user smart device having a user smart device application for displaying drone location information; and
f. said cellular module transmit said remote ID information to said cloud database;
g. said remote ID detection and deconfliction system utilizes a flight deconfliction algorithm to determine the best course of action to avoid a collision; and

3. The remote ID detection and deconfliction system for at least one UAV of claim 1 wherein said at least one UAV remote ID information includes a at least one UAV ID, at least one UAV coordinates, at least one UAV velocity, at least one UAV altitude and emergency status of aircraft.

4. The remote ID detection and deconfliction system for at least one UAV of claim 1 wherein said a wireless network protocol and said remote ID detection device wireless network protocol is selected from the group consisting of Wi-Fi and Bluetooth.

5. The remote ID detection and deconfliction system for at least one UAV of claim 1 wherein said remote ID detection device receives remote ID information and said remote ID information includes a at least one UAV ID, at least one UAV coordinates, at least one UAV velocity, and at least one UAV altitude.

6. The remote ID detection and deconfliction system for at least one UAV of claim 1 wherein said cellular module transmits using a cellular protocol vector, coordinate, altitude, and velocity of said at least one UAV using a cellular protocol to a to the cell tower and said cell tower transmits vector, coordinate, altitude, and velocity of said at least one UAV to said cloud server.

7. The remote ID detection and deconfliction system for at least one UAV of claim 1 wherein said cloud server transmits vector, coordinate, altitude, and velocity of said at least one UAV to an application on a computer.

8. The remote ID detection and deconfliction system for at least one UAV of claim 1 wherein said cloud server transmits vector, coordinate, altitude, and velocity of said at least one UAV to an application on a smart device or a computer.

9. A remote ID detection and deconfliction system for at least one UAV comprising:
a. said at least one UAV capable of emitting remote ID information via a wireless network protocol using a wireless transceiver;
b. a remote ID detection device capable of receiving said remote ID information via a wireless network protocol using a wireless transceiver;
c. a cellular module;
d. a cloud server and said cloud server having a cloud database;
e. a user smart device having a user smart device application for displaying drone location information;
f. said cellular module transmit said remote ID information to said cloud database;
g. said remote ID detection and deconfliction system utilizes a flight deconfliction algorithm to determine the best course of action to avoid a collision; and
h. flight deconfliction algorithm uses an API transmits latitude, longitude, and flight deconfliction avoidance recommendations and messages of remote ID equipment aircraft to said user smart device.

10. The remote ID detection and deconfliction system for at least one UAV of claim 1 wherein said at least one UAV remote ID information includes a at least one UAV ID, at least one UAV coordinates, at least one UAV velocity, at least one UAV altitude and emergency status of aircraft.

11. The remote ID detection and deconfliction system for at least one UAV of claim 1 wherein said a wireless network protocol is selected from the group consisting of Wi-Fi and Bluetooth.

12. The remote ID detection and deconfliction system for at least one UAV of claim 1 wherein said remote ID detection device wireless network protocol is selected from the group consisting of a Bluetooth and Wi-Fi Receiver.

13. The remote ID detection and deconfliction system for at least one UAV of claim 1 wherein said remote ID detection device receives remote ID information and said remote ID information includes a at least one UAV ID, at least one UAV coordinates, at least one UAV velocity, and at least one UAV altitude.

14. The remote ID detection and deconfliction system for at least one UAV of claim 1 wherein said cellular module transmits using a cellular protocol.

15. The remote ID detection and deconfliction system for at least one UAV of claim 1 wherein said cellular module transmits using a cellular protocol to a to the cell tower.

16. The remote ID detection and deconfliction system for at least one UAV of claim 1 wherein said cellular module transmits vector, coordinate, altitude, and velocity of said at least one UAV using a cellular protocol to a to the cell tower.

17. The remote ID detection and deconfliction system for at least one UAV of claim 1 wherein said cell tower transmits vector, coordinate, altitude, and velocity of said at least one UAV to said cloud server.

18. The remote ID detection and deconfliction system for at least one UAV of claim 1 wherein said cloud server transmits vector, coordinate, altitude, and velocity of said at least one UAV to an application on a computer.

19. The remote ID detection and deconfliction system for at least one UAV of claim 1 wherein said cloud server transmits vector, coordinate, altitude, and velocity of said at least one UAV to an application on a smart device.

20. The remote ID detection and deconfliction system for at least one UAV of claim 1 wherein said cloud server transmits vector, coordinate, altitude, and velocity of said at least one UAV to an application on a computer.
